(19) United States
(12) Patent Application Publication
(10) Pub. No.: US 2026/0019741 A1
(43) Pub. Date: Jan. 15, 2026

(54) SPEAKER MODULE

(71) Applicant: Acer Incorporated, New Taipei City (TW)

(72) Inventors: Po-Jen TU, New Taipei City (TW); Jia-Ren CHANG, New Taipei City (TW); Kai-Meng TZENG, New Taipei City (TW); Chien-Chung CHEN, New Taipei City (TW)

(21) Appl. No.: 19/260,787

(22) Filed: Jul. 7, 2025

(30) Foreign Application Priority Data
Jul. 10, 2024 (TW) 113125747

(51) Int. Cl. H04R 1/28; H04R 1/24; H04R 9/04; H04R 9/06

(52) U.S. Cl. CPC H04R 1/2896; H04R 1/24; H04R 9/046; H04R 9/06; H04R 2400/11

(57) ABSTRACT

A speaker module includes a base, a first speaker assembly, a second speaker assembly, a third speaker assembly, and a fourth speaker assembly. The first speaker assembly is disposed on the base. The second speaker assembly is disposed on the base and is symmetrical to the first speaker assembly. The third speaker assembly is disposed on the base. The fourth speaker assembly is disposed on the base and is symmetrical to the third speaker assembly. The first speaker assembly and the second speaker assembly are arranged along a first axis, the third speaker assembly and the fourth speaker assembly are arranged along a second axis, and the first axis is perpendicular to the second axis.

### CROSS REFERENCE TO RELATED APPLICATIONS

This application claims the benefit of Taiwan Patent Application No. 113125747, filed Jul. 10, 2024, the entirety of which is incorporated by reference herein.

### BACKGROUND OF THE INVENTION

### Field of the Disclosure

The present disclosure relates to a speaker module, and in particular it relates to a speaker module capable of reducing overall vibration and improving output performance.

### Description of the Related Art

As technology has developed, many of today's electronic devices (such as notebook computers) have become quite popular products. These notebook computers are among the most popular and widespread of today's consumer products. Users can execute various applications on notebook computers to achieve various purposes, such as watching videos, playing games, browsing the web, and reading e-books.

Generally speaking, electronic devices such as notebook computers are equipped with at least one speaker module configured to provide sound, including music. However, existing speaker modules generate unnecessary vibration when emitting sound, and these vibrations may result in contact with the housing of the notebook computer, causing noise and consequently affecting the sound performance of the speaker module.

Therefore, how to design a speaker module that can avoid unnecessary vibrations is a topic that needs to be discussed.

### BRIEF SUMMARY OF THE INVENTION

Accordingly, one objective of the present disclosure is to provide a speaker module to solve the above problems.

According to some embodiments of the disclosure, the present disclosure provides a speaker module includes a base, a first speaker assembly, a second speaker assembly, a third speaker assembly, and a fourth speaker assembly. The first speaker assembly is disposed on the base. The second speaker assembly is disposed on the base and is symmetrical to the first speaker assembly. The third speaker assembly is disposed on the base. The fourth speaker assembly is disposed on the base and is symmetrical to the third speaker assembly. The first speaker assembly and the second speaker assembly are arranged along a first axis, the third speaker assembly and the fourth speaker assembly are arranged along a second axis, and the first axis is perpendicular to the second axis.

According to some embodiments, the base is made of metal material, and when viewed along a third axis, the base has an H-shaped structure. The third axis is perpendicular to the first axis and the second axis.

According to some embodiments, the base has a first base plate, a second base plate and a third base plate, the second base plate and the third base plate are perpendicular to the first base plate.

According to some embodiments, the first speaker assembly and the second speaker assembly respectively have a first framework and a second frame, which are fixedly disposed on the second base plate and the third base plate.

According to some embodiments, the first speaker assembly and the second speaker assembly respectively have a first coil and a second coil, and the first base plate separates the first coil from the second coil.

According to some embodiments, the third speaker assembly and the fourth speaker assembly respectively have a third framework and a fourth framework, which are respectively fixedly disposed on the second base plate and the third base plate.

According to some embodiments, the third speaker assembly and the fourth speaker assembly respectively have a third coil and a fourth coil, the second base plate separates the first coil from the third coil, and the third base plate separates the second coil from the fourth coil.

According to some embodiments, the first framework to the fourth framework are formed on the base by insert molding technology.

According to some embodiments, when viewed along the second axis, the first framework overlaps a portion of the third framework, and the first framework overlaps a portion of the fourth framework.

According to some embodiments, the first coil is connected to the second coil in parallel, and the third coil is connected to the fourth coil in parallel.

According to some embodiments, the first coil is electrically independent of the third coil.

According to some embodiments, the speaker module further includes a first electrical contact and a second electrical contact, the positive terminals of the first coil and the second coil are electrically connected to the first electrical contact, and the negative terminals of the first coil and the second coil are electrically connected to the second electrical contact.

According to some embodiments, the speaker module further includes a third electrical contact and a fourth electrical contact, the positive terminals of the third coil and the fourth coil are electrically connected to the third electrical contact, and the negative terminals of the third coil and the fourth coil are electrically connected to the fourth electrical contact.

According to some embodiments, the first electrical contact and the second electrical contact are located on the first side of the base, the third electrical contact and the fourth electrical contact are located on the second side of the base, and the second side is opposite to the first side.

According to some embodiments, the first coil is connected to the second coil in series, and the third coil is connected to the fourth coil in series.

According to some embodiments, the third coil and the fourth coil are connected to the first coil and the second coil in parallel.

According to some embodiments, the speaker module further includes a first electrical contact and a second electrical contact, which are respectively disposed on two of the first to fourth frameworks.

According to some embodiments, the first coil and the third coil are electrically connected to the first electrical contact, and the second coil and the fourth coil are electrically connected to the second electrical contact.

According to some embodiments, the size of the first speaker assembly is larger than the size of the third speaker assembly.

The present disclosure provides a speaker module, which includes a base and a first speaker assembly to a fourth speaker assembly. The first speaker assembly is symmetrical to the second speaker assembly, and the first speaker assembly and the second speaker assembly have the same size, material, and parameters. Similarly, the third speaker assembly is symmetrical to the fourth speaker assembly, and the third speaker assembly and the fourth speaker assembly have the same size, material, and parameters.

When the first speaker assembly and the second speaker assembly receive current, the first electromagnetic driving force and the second electromagnetic driving force that drive the first diaphragm and the second diaphragm to vibrate are of the same magnitude but opposite directions, so that the base will not be affected by the above electromagnetic driving forces. That is, the base does not move along the Z-axis when the speaker module emits sound. Similarly, the third electromagnetic driving force and the fourth electromagnetic driving force generated by the third speaker assembly and the fourth speaker assembly are equal in magnitude but opposite in direction, so that the base does not move along the X-axis when the speaker module emits sound.

Based on the design of the present disclosure, when the speaker module receives the current signal and emits sound, the speaker module does not generate displacement along the X-axis or Z-axis. Therefore, when the speaker module is installed on any electronic device (such as a tablet computer or a smartphone), it does not cause vibration noise and affect the sound effect output by the speaker module. In addition, since four speaker assembly (driver units) are arranged in a single module, the output volume of the speaker module can be increased, and the output frequency range can also be increased, so that the user has a better auditory experience.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a three-dimensional schematic diagram of a speaker module 10 according to an embodiment of the present disclosure.

FIG. 2 is a three-dimensional diagram of a partial structure of the speaker module 10 according to an embodiment of the present disclosure.

FIG. 3 is an exploded diagram of a partial structure of the speaker module 10 according to an embodiment of the present disclosure.

FIG. 4 is a three-dimensional diagram of a partial structure of the speaker module 10 according to an embodiment of the present disclosure.

FIG. 5 is a cross-sectional view of the speaker module 10 along line A-A in FIG. 2 according to an embodiment of the present disclosure.

FIG. 6 is a circuit diagram of the first coil CL1 to the fourth coil CL4 according to an embodiment of the present disclosure.

FIG. 7 is a circuit diagram of the first coil CL1 to the fourth coil CL4 according to another embodiment of the present disclosure.

FIG. 8 is a front view of a partial structure of the speaker module 10 according to another embodiment of the present disclosure.

FIG. 9 is a chart illustrating the relationship between frequency and sound pressure level of the speaker module 10 according to an embodiment of the present disclosure and a conventional speaker module.

FIG. 10 is a chart illustrating the relationship between frequency and impedance of the speaker module 10 according to an embodiment of the present disclosure and the conventional speaker module.

FIG. 11 is a chart illustrating the relationship between the vibration displacement and the frequency of the conventional speaker module.

FIG. 12 is a chart illustrating the relationship between the vibration displacement and the frequency of the speaker module 10 according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

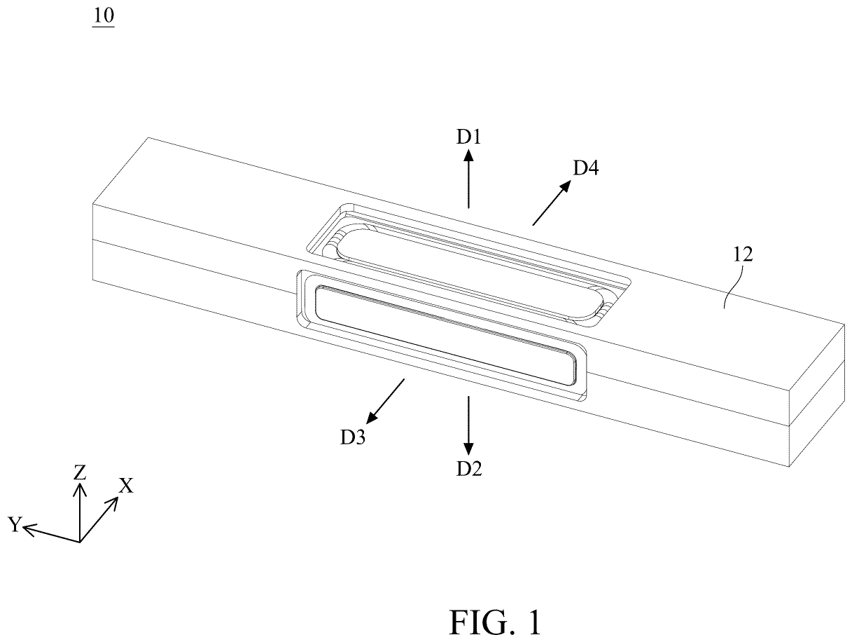

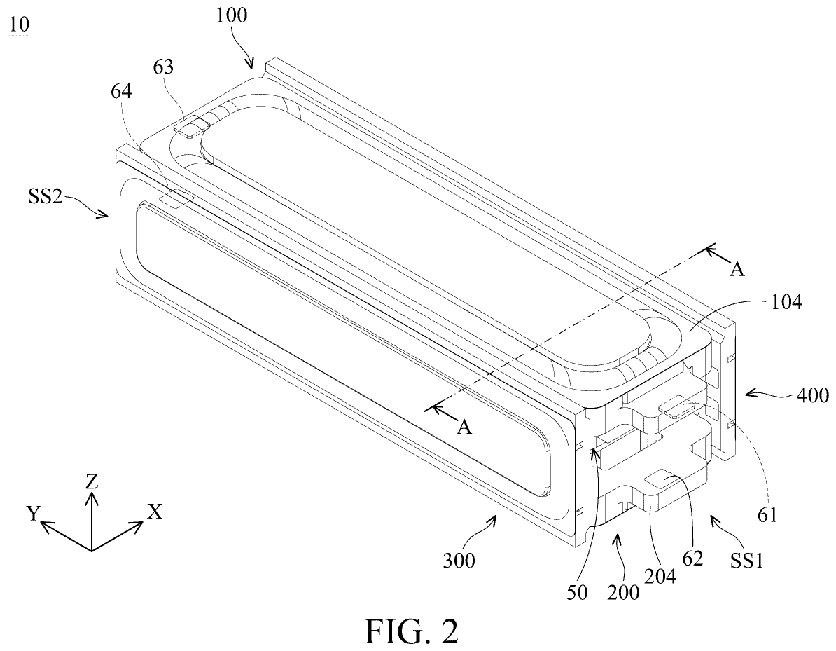

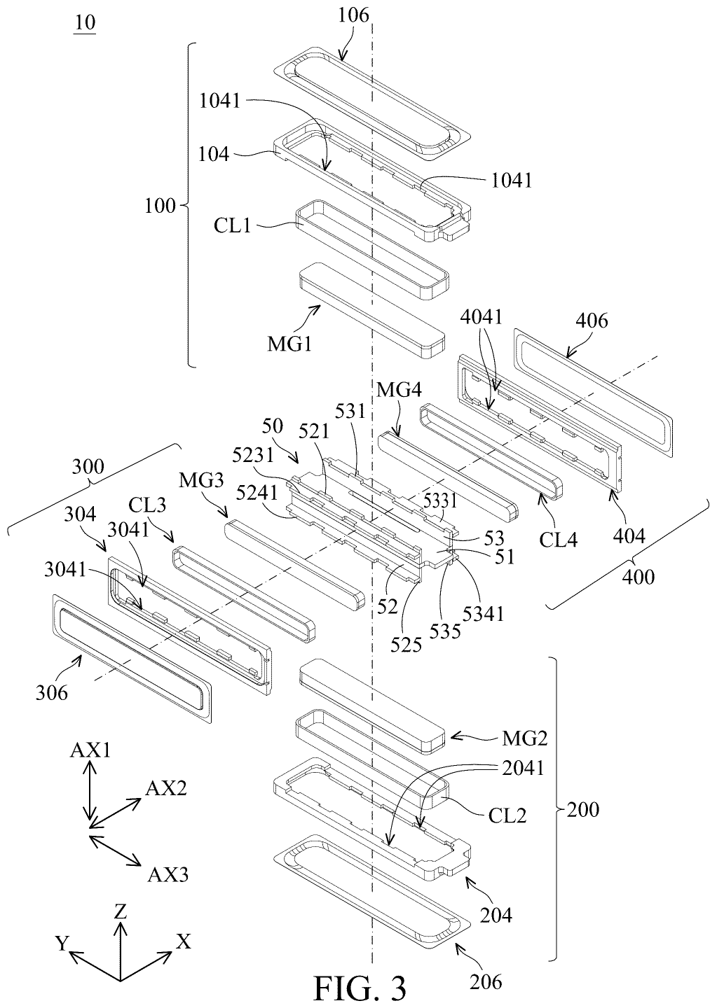

Please refer to FIG. 1 to FIG. 3. FIG. 1 is a three-dimensional schematic diagram of a speaker module 10 according to an embodiment of the present disclosure, FIG. 2 is a three-dimensional diagram of a partial structure of the speaker module 10 according to an embodiment of the present disclosure, and FIG. 3 is an exploded diagram of a partial structure of the speaker module 10 according to an embodiment of the present disclosure. In this embodiment, the speaker module 10 may include a casing 12, a base 50, a first speaker assembly 100, a second speaker assembly 200, a third speaker assembly 300, and a fourth speaker assembly 400.

As shown in FIG. 1 and FIG. 3, the first speaker assembly 100, the second speaker assembly 200, the third speaker assembly 300, and the fourth speaker assembly 400 are disposed on the base 50, and the casing 12 is sleeved on these speaker assemblies. As shown in FIG. 1, four openings are disposed on the casing 12 so that the first speaker assembly 100, the second speaker assembly 200, the third speaker assembly 300, and the fourth speaker assembly 400 emit sound toward a first direction D1, a second direction D2, a third direction D3, and a fourth direction D4, respectively.

As shown in FIG. 2 and FIG. 3, the first speaker assembly 100 and the second speaker assembly 200 are arranged along a first axis AX1 (the Z-axis), and the third speaker assembly 300 and the fourth speaker assembly 400 are arranged along a second axis AX2 (the X-axis), and the first axis AX1 is perpendicular to the second axis AX2.

In this embodiment, the second speaker assembly 200 is symmetrical to the first speaker assembly 100. The fourth speaker assembly 400 is symmetrical to the third speaker assembly 300. That is, the second speaker assembly 200 and the first speaker assembly 100 have the same component configuration, size, material, and parameters. Similarly, the fourth speaker assembly 400 and the third speaker assembly 300 have the same component configuration, size, material, and parameters.

In addition, in this embodiment, the size of the first speaker assembly 100 is larger than the size of the third speaker assembly 300. For example, the first speaker assembly 100 has a length of 32 mm and a width of 9 mm, and the third speaker assembly 300 has a length of 32 mm and a width of 7 mm, but they are not limited thereto. Based on such a configuration, the speaker module 10 has a reduced height along the Z-axis, and therefore can be applied to an ultra-thin notebook computer.

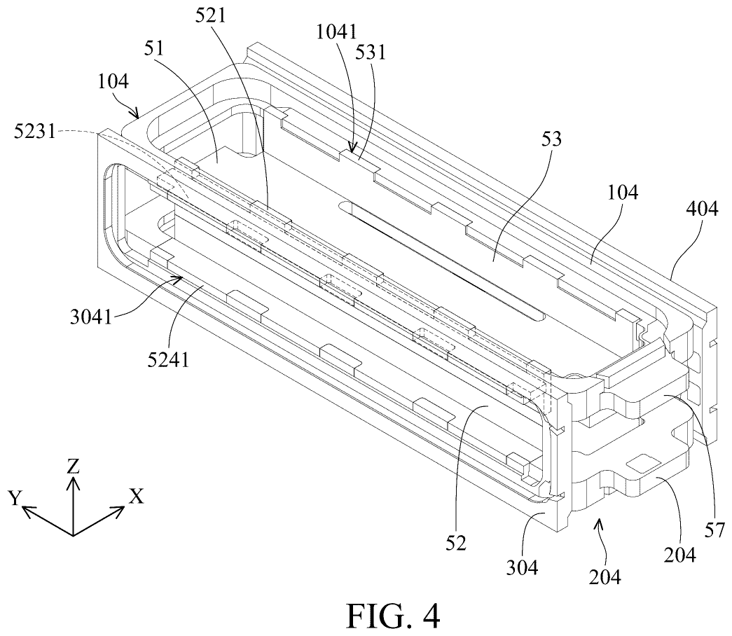

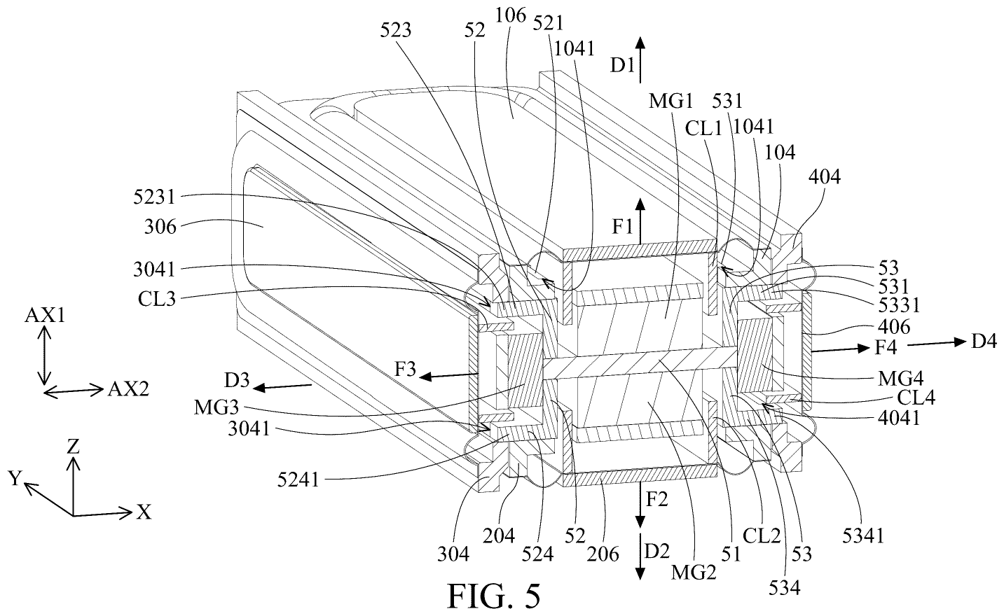

Please refer to FIG. 2 to FIG. 5. FIG. 4 is a three-dimensional diagram of a partial structure of the speaker module 10 according to an embodiment of the present disclosure, and FIG. 5 is a cross-sectional view of the speaker module 10 along line A-A in FIG. 2 according to an embodiment of the present disclosure. In this embodiment, the base 50 may be made of metal material, such as cold-rolled steel sheet, but it is not limited thereto.

Furthermore, as shown in FIG. 3 and FIG. 4, when viewed along a third axis AX3, the base 50 has an H-shaped structure. The third axis AX3 is perpendicular to the first axis AX1 and the second axis AX2.

As shown in FIG. 4, the base 50 includes a first base plate 51, a second base plate 52 and a third base plate 53. The second base plate 52 and the third base plate 53 are perpendicular to the first base plate 51, and the first base plate 51, the second base plate 52 and the third base plate 53 can be integrally formed as one piece, but they are not limited thereto. For example, they can also be connected to each other by welding.

As shown in FIG. 3, the first speaker assembly 100 may include a first framework 104, a first diaphragm 106, a first coil CL1, and a first magnet MG1. The first diaphragm 106 is movably connected to the first framework 104, the first coil CL1 is connected to the bottom of the first diaphragm 106, the first coil CL1 surrounds the first magnet MG1, and the first magnet MG1 is fixedly disposed on the first base plate 51.

Similarly, the second speaker assembly 200 has a second framework 204, a second diaphragm 206, a second coil CL2, and a second magnet MG2. Since the second speaker assembly 200 is symmetrical to the first speaker assembly 100, its configuration is the same as the configuration of the first speaker assembly 100, and thus it is omitted herein.

As shown in FIG. 3 to FIG. 5, the second base plate 52 has a plurality of protruding portions 521 which are configured to engage with a plurality of grooves 1041 of the first framework 104, and the third base plate 53 has a plurality of protruding portions 531 which are configured to engage with a plurality of grooves 1041 on another side of the first framework 104. Similarly, the second base plate 52 has a plurality of protruding portions 525 which are configured to engage with the plurality of grooves 2041 of the second framework 204, and the third base plate 53 has a plurality of protruding portions 535 which are configured to engage with a plurality of grooves 2041 on another side of the second framework 204.

Furthermore, as shown in FIG. 5, the second base plate 52 further includes a first platform portion 523 and a second platform portion 524 which protrude in the third direction D3, and the third base plate 53 further includes a third platform portion 533 and a fourth platform portion 534 which protrude in the fourth direction D4.

As shown in FIG. 5, the first framework 104 and the second framework 204 are fixedly disposed on the second base plate 52 and the third base plate 53. Specifically, the first framework 104 is disposed on the first platform portion 523 and the third platform portion 533, and the second framework 204 is disposed on the second platform portion 524 and the fourth platform portion 534.

When the first coil CL1 and the second coil CL2 receive a current (for example, an alternating current), the first magnet MG1 acts with the first coil CL1 to generate a first electromagnetic driving force F1, so that the first coil CL1 drives the first diaphragm 106 to move. At the same time, the second magnet MG2 acts with the second coil CL2 to generate a second electromagnetic driving force F2, so that the second coil CL2 drives the second diaphragm 206 to move. The displacement of the first diaphragm 106 and the displacement of the second diaphragm 206 have the same in magnitude but opposite directions.

For example, the waveform of the current may be a sine wave, and when the phase of the current is 0 to 180 degrees, the first diaphragm 106 may generate a first displacement in the first direction D1, and the second diaphragm 206 may generate a second displacement in the second direction D2. On the contrary, when the phase of the current is 180 to 360 degrees, the first diaphragm 106 may generate the first displacement in the second direction D2, and the second diaphragm 206 may generate the second displacement in the first direction D1. In this embodiment, the first electromagnetic driving force F1 and the second electromagnetic driving force F2 have the same amplitude, so that the first displacement and the second displacement have the same magnitude but opposite directions.

Based on the above design, when the first speaker assembly 100 and the second speaker assembly 200 receive the current, since the first electromagnetic driving force F1 and the second electromagnetic driving force F2 that drive the first diaphragm 106 and the second diaphragm 206 to vibrate are of the same magnitude but opposite directions, the base 50 will not be affected by the above electromagnetic driving forces. That is, the base 50 does not move along the Z-axis when the speaker module 10 emits sound.

It is worth noting that, as shown in FIG. 5, the first base plate 51 separates the first coil CL1 from the second coil CL2, so that when the first coil CL1 and the second coil CL2 respectively drive the first diaphragm 106 and the second diaphragm 206 to move, the movements of the first coil CL1 and the second coil CL2 do not interfere with each other.

Similarly, as shown in FIG. 3 and FIG. 5, the third speaker assembly 300 may include a third framework 304, a third diaphragm 306, a third coil CL3, and a third magnet MG3. The third diaphragm 306 is movably connected to the third framework 304, the third coil CL3 is connected to the bottom of the third diaphragm 306, the third coil CL3 surrounds the third magnet MG3, and the third magnet MG3 is fixedly disposed on the second base plate 52.

The fourth speaker assembly 400 has a fourth framework 404, a fourth diaphragm 406, a fourth coil CL4 and a fourth magnet MG4. Since the fourth speaker assembly 400 is symmetrical to the third speaker assembly 300, its configuration is the same as the configuration of the third speaker assembly 300, and thus it is omitted herein.

The third framework 304 and the fourth framework 404 are fixedly disposed on the second base plate 52 and the third base plate 53 respectively. Specifically, as shown in FIG. 3 to FIG. 5, the first platform portion 523 has a plurality of protruding portions 5231, and the second platform portion 524 has a plurality of protruding portions 5241, which are configured to engage with a plurality of grooves 3041 of the third framework 304.

Similarly, the third platform portion 533 has a plurality of protruding portions 5331, and the fourth platform portion 534 has a plurality of protruding portions 5341, which are configured to engage with a plurality of grooves 4041 of the fourth framework 404.

Similar to the first speaker assembly 100 and the second speaker assembly 200, when the third coil CL3 and the fourth coil CL4 receive a current (for example, an alternating current), the third magnet MG3 acts with the third coil CL3 to generate a third electromagnetic driving force F3, so that the third coil CL3 drives the third diaphragm 306 to move. In addition, at the same time, the fourth magnet MG4 acts with the fourth coil CL4 to generate a fourth electromagnetic driving force F4, so that the fourth coil CL4 drives the fourth diaphragm 406 to move, and the displacement of the third diaphragm 306 is the same as the displacement of the fourth diaphragm 406 but in the opposite directions.

Based on the above design, when the third speaker assembly 300 and the fourth speaker assembly 400 receive the current, since the third electromagnetic driving force F3 and the fourth electromagnetic driving force F4 that drive the third diaphragm 306 and the fourth diaphragm 406 to vibrate are of the same magnitude but opposite directions, the base 50 will not be affected by the above electromagnetic driving forces. That is, the base 50 does not move along the X-axis when the speaker module 10 emits sound.

It should be note that, as shown in FIG. 5, the second base plate 52 separates the first coil CL1 from the third coil CL3, and the third base plate 53 separates the second coil CL2 from the fourth coil CL4. Therefore, when the third coil CL3 and the fourth coil CL4 respectively drive the third diaphragm 306 and the fourth diaphragm 406 to move, the movements of the third coil CL3 and the fourth coil CL4 do not interfere with each other, and the movements of the third coil CL3 and the fourth coil CL4 do not interfere with the movements of the first coil CL1 and the second coil CL2.

As shown in FIG. 5, when viewed along the second axis AX2, the first framework 104 overlaps a portion of the third framework 304, and the first framework 104 overlaps a portion of the fourth framework 404. Similarly, when viewed along the second axis AX2, the second framework 204 overlaps a portion of the third framework 304, and the second framework 204 overlaps a portion of the fourth framework 404.

In addition, it should be noted that in this embodiment, the first framework 104 to the fourth framework 404 are engaged with the base 50, but it is not limited thereto. In other embodiments, the first to fourth frameworks 104 to 404 may be formed on the base 50 by insert molding technology.

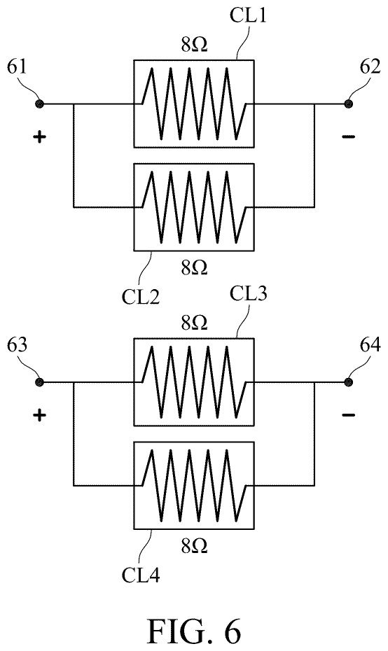

Please refer to FIGS. 2 and 6. FIG. 6 is a circuit diagram of the first coil CL1 to the fourth coil CL4 according to an embodiment of the present disclosure. In this embodiment, the first coil CL1 is connected to the second coil CL2 in parallel, the third coil CL3 is connected to the fourth coil CL4 in parallel, and the first coil CL1 is electrically independent of the third coil CL3.

That is, the electrical signal provided to the first coil CL1 and the second coil CL2 may be different from the electrical signal provided to the third coil CL3 and the fourth coil CL4. For example, the frequencies of two electrical signals are different. For example, based on such a configuration, the first speaker assembly 100 and the second speaker assembly 200 can be configured to emit high-frequency sounds, while the third speaker assembly 300 and the fourth speaker assembly 400 can be configured to emit low-frequency sounds, so that the mixed sounds can have a better output effect.

In this embodiment, as shown in FIG. 2 and FIG. 6, the speaker module 10 further includes a first electrical contact 61 and a second electrical contact 62. The positive terminals of the first coil CL1 and the second coil CL2 are electrically connected to the first electrical contact 61, and the negative terminals of the first coil CL1 and the second coil CL2 are electrically connected to the second electrical contact 62.

Furthermore, the speaker module further includes a third electrical contact 63 and a fourth electrical contact 64. The positive terminals of the third coil CL3 and the fourth coil CL4 are electrically connected to the third electrical contact 63, and the negative terminals of the third coil CL3 and the fourth coil CL4 are electrically connected to the fourth electrical contact 64. In this embodiment, the impedance of each of the first coil CL1 to the fourth coil CL4 may be 8 ohms, but they are not limited thereto.

As shown in FIG. 2, the first electrical contact 61 and the second electrical contact 62 are located on a first side SS1 of the base 50, the third electrical contact 63 and the fourth electrical contact 64 are located on a second side SS2 of the base 50, and the second side SS2 is opposite to the first side SS1.

In this embodiment, the first electrical contact 61 and the second electrical contact 62 are respectively disposed on the first framework 104 and the second framework 204, and the third electrical contact 63 and the fourth electrical contact 64 are respectively disposed on the first framework 104 and the second framework 204, but they are not limited thereto. The first electrical contact 61 to the fourth electrical contact 64 may be metal welding pads, so that the wires of the first coil CL1 to the fourth coil CL4 can be welded thereon and electrically connected to an external circuit.

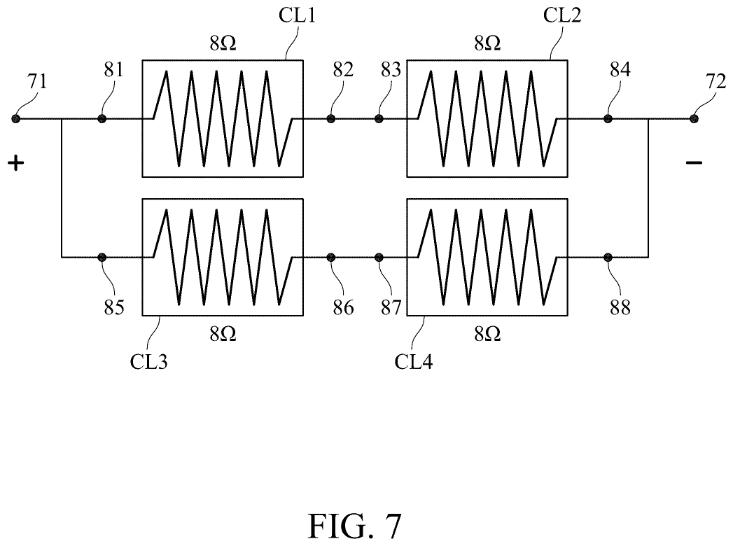

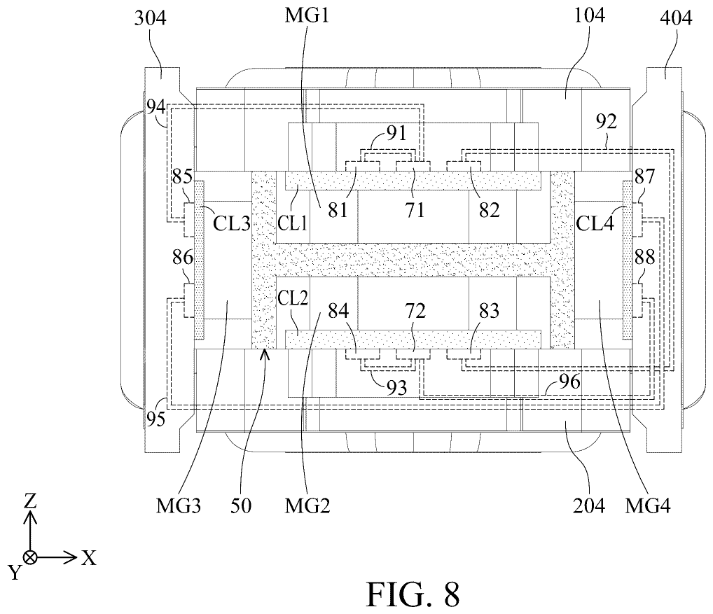

Please refer to FIG. 7 and FIG. 8. FIG. 7 is a circuit diagram of the first coil CL1 to the fourth coil CL4 according to another embodiment of the present disclosure, and FIG. 8 is a front view of a partial structure of the speaker module 10 according to another embodiment of the present disclosure.

In this embodiment, the first coil CL1 and the second coil CL2 are connected in series, the third coil CL3 and the fourth coil CL4 are connected in series, and the third coil CL3 and the fourth coil CL4 are connected to the first coil CL1 and the second coil CL2 in parallel. In this embodiment, the impedance of each of the first coil CL1 to the fourth coil CL4 may be 8 ohms, but they are not limited thereto.

The speaker module 10 further includes a first electrical contact 71 and a second electrical contact 72, which are respectively disposed on two of the first framework 104 to the fourth framework 404. The first coil CL1 and the third coil CL3 are electrically connected to the first electrical contact 71, and the second coil CL2 and the fourth coil CL4 are electrically connected to the second electrical contact 72.

Specifically, as shown in FIG. 8, the first electrical contact 71 and the second electrical contact 72 can be metal pads which are disposed on the first framework 104 and the second framework 204, respectively. Furthermore, the speaker module 10 may further include a plurality of metal pads 81 to 88 which are configured to be disposed on the corresponding framework, and the speaker module 10 may further include a plurality of metal connection members 91 to 96 which are configured to be disposed in the corresponding framework.

In this embodiment, the first framework 104 to the fourth framework 404 can be made of plastic material, and the metal pads 81 to 88 and the metal connection members 91 to 96 can be partially disposed in the corresponding frameworks by the insert molding technology.

In this embodiment, the positive terminal and the negative terminal of the first coil CL1 are respectively electrically connected to the metal pads 81 and 82, respectively, the positive terminal and the negative terminal of the second coil CL2 are respectively electrically connected to the metal pads 83 and 84, the positive terminal and the negative terminal of the third coil CL3 are respectively electrically connected to the metal pads 85 and 86, and the positive terminal and the negative terminal of the fourth coil CL4 are respectively electrically connected to metal pads 87 and 88.

As shown in FIG. 8, the metal pad 81 is electrically connected to the first electrical contact 71 via the metal connection member 91, the metal pad 82 is electrically connected to the metal pad 83 via the metal connection member 92, and the metal pad 84 is electrically connected to the second electrical contact 72 via the metal connection member 93.

Similarly, the metal pad 85 is electrically connected to the first electrical contact 71 via the metal connection member 94, the metal pad 86 is electrically connected to the metal pad 87 via the metal connection member 95, and the metal pad 88 is electrically connected to the second electrical contact 72 via the metal connection member 96.

Based on the configuration of the above-mentioned metal pads 81 to 88 and the metal connection members 91 to 96, the operator only needs to weld the wires of the first coil CL1 to the fourth coil CL4 to the metal pads 81 to 88 to achieve the circuit connection method of FIG. 7, without the need to use additional wires to connect the first coil CL1 to the fourth coil CL4, thereby increasing the convenience of assembly and further increasing production efficiency.

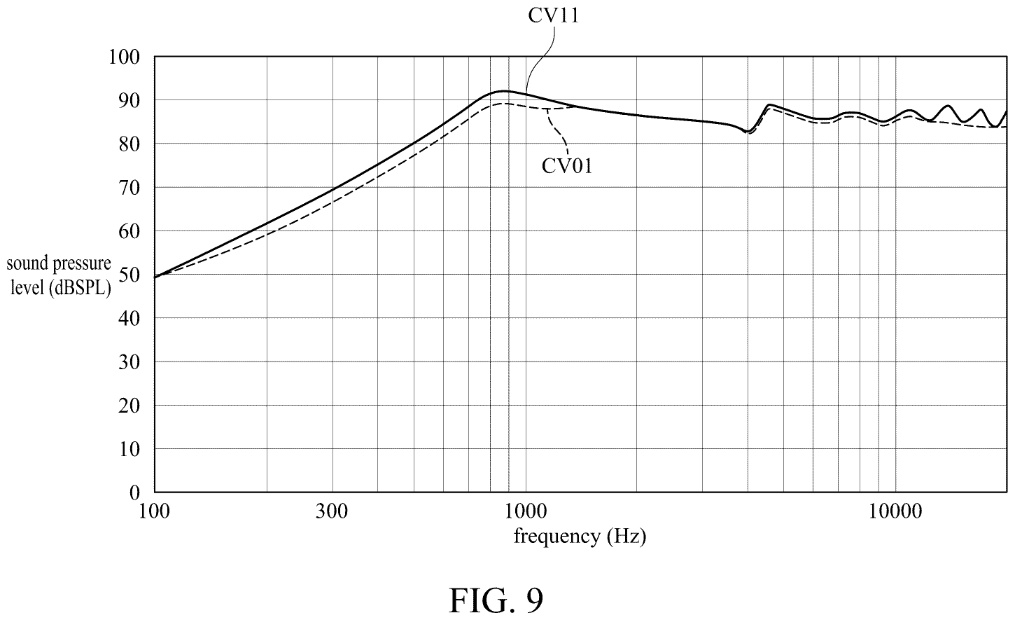

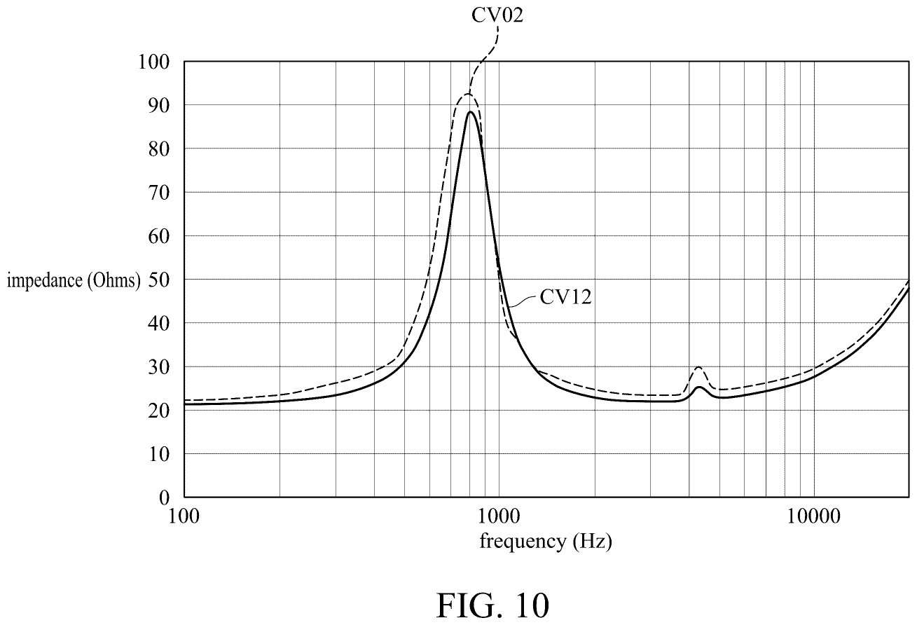

Please refer to FIG. 9 and FIG. 10. FIG. 9 is a chart illustrating the relationship between frequency and sound pressure level of the speaker module 10 according to an embodiment of the present disclosure and a conventional speaker module. FIG. 10 is a chart illustrating the relationship between frequency and impedance of the speaker module 10 according to an embodiment of the present disclosure and the conventional speaker module.

In FIG. 9, the curve CV01 represents the sound pressure level curve of the conventional speaker module at different frequencies, and the curve CV11 represents the sound pressure level curve of the speaker module 10 of the present disclosure at different frequencies. As shown in FIG. 9, when the frequency is above 300 Hz, the sound pressure level (SPL) of the curve CV11 is approximately 3 dB higher than that of the curve CV01, which means that the speaker module 10 of the present disclosure has a better sound output performance.

Furthermore, in FIG. 10, the curve CV02 represents the impedance curve of the conventional speaker module at different frequencies, and the curve CV12 represents the impedance curve of the speaker module 10 of the present disclosure at different frequencies. As shown in FIG. 10, the waveform of curve CV02 is not much different from the waveform of the curve CV12. That is, while achieving the vibration reduction effect, the output performance of the speaker module 10 is not greatly affected.

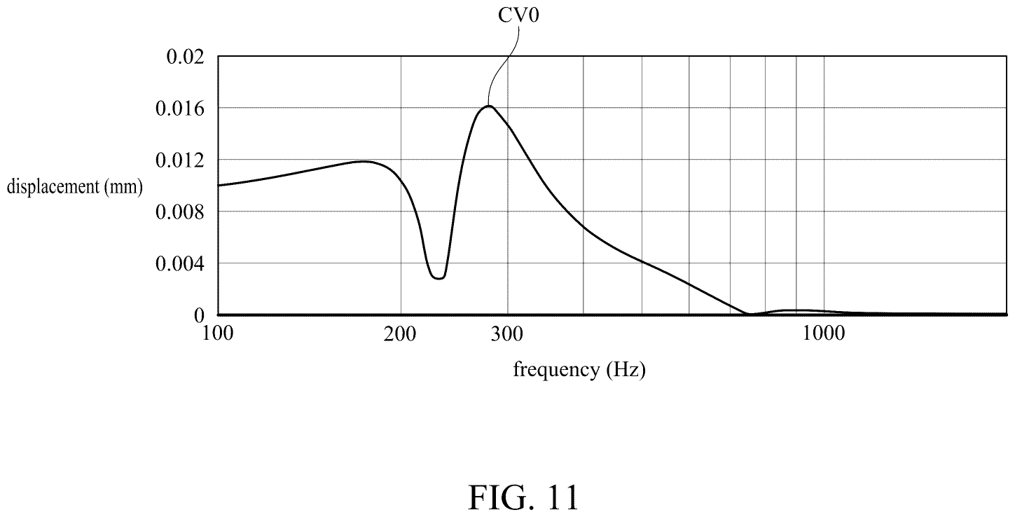

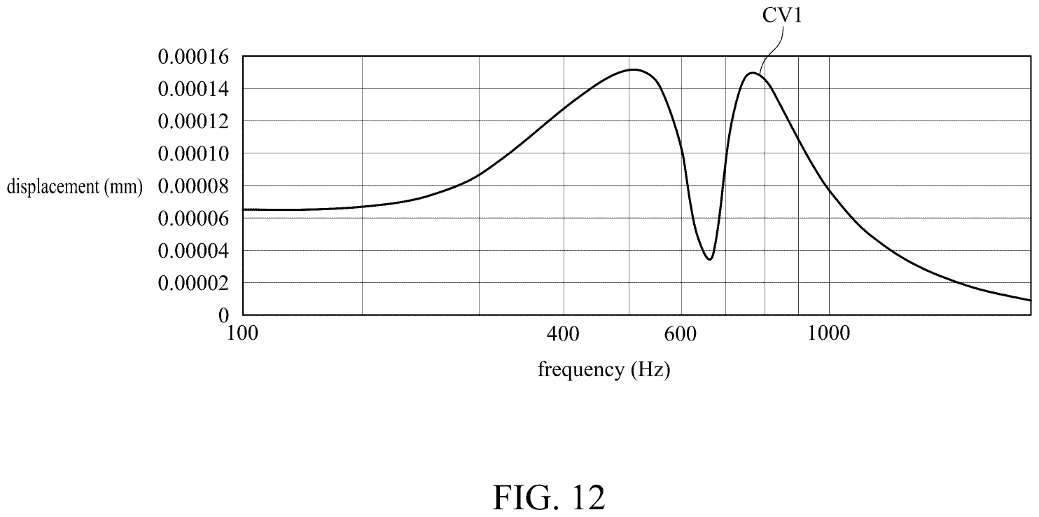

Please refer to FIGS. 11 and 12. FIG. 11 is a chart illustrating the relationship between the vibration displacement and the frequency of the conventional speaker module, and FIG. 12 is a chart illustrating the relationship between the vibration displacement and the frequency of the speaker module 10 according to an embodiment of the present disclosure.

As shown by the curve CV0 in FIG. 11, the conventional speaker module has a maximum vibration displacement (such as 0.017 mm) between frequency of 200 Hz and 300 Hz. Furthermore, as shown by the curve CV1, the maximum vibration displacement of the speaker module 10 in this embodiment between the frequency of 400 Hz and 600 Hz can be reduced to less than 0.00015 mm.

According to the above charts, the configuration provided by the present disclosure can effectively reduce the vibration generated by the first diaphragm 106 to the fourth diaphragm 406. For example, the displacement generated by the vibration can be reduced by approximately 99%.

In conclusion, the present disclosure provides a speaker module 10, which includes a base 50 and a first speaker assembly 100 to a fourth speaker assembly 400. The first speaker assembly 100 is symmetrical to the second speaker assembly 200, and the first speaker assembly 100 and the second speaker assembly 200 have the same size, material, and parameters. Similarly, the third speaker assembly 300 is symmetrical to the fourth speaker assembly 400, and the third speaker assembly 300 and the fourth speaker assembly 400 have the same size, material, and parameters.

When the first speaker assembly 100 and the second speaker assembly 200 receive current, the first electromagnetic driving force F1 and the second electromagnetic driving force F2 that drive the first diaphragm 106 and the second diaphragm 206 to vibrate are of the same magnitude but opposite directions, so that the base 50 will not be affected by the above electromagnetic driving forces. That is, the base 50 does not move along the Z-axis when the speaker module 10 emits sound. Similarly, the third electromagnetic driving force F3 and the fourth electromagnetic driving force F4 generated by the third speaker assembly 300 and the fourth speaker assembly 400 are equal in magnitude but opposite in direction, so that the base 50 does not move along the X-axis when the speaker module 10 emits sound.

Based on the design of the present disclosure, when the speaker module 10 receives the current signal and emits sound, the speaker module 10 does not generate displacement along the X-axis or Z-axis. Therefore, when the speaker module 10 is installed on any electronic device (such as a tablet computer or a smartphone), it does not cause vibration noise and affect the sound effect output by the speaker module 10. In addition, since four speaker assembly (driver units) are arranged in a single module, the output volume of the speaker module 10 can be increased, and the output frequency range can also be increased, so that the user has a better auditory experience.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A speaker module, comprising:
a base;
a first speaker assembly, disposed on the base;
a second speaker assembly, disposed on the base and symmetrical to the first speaker assembly;
a third speaker assembly, disposed on the base; and
a fourth speaker assembly, disposed on the base and symmetrical to the third speaker assembly;
wherein the first speaker assembly and the second speaker assembly are arranged along a first axis, the third speaker assembly and the fourth speaker assembly are arranged along a second axis, and the first axis is perpendicular to the second axis.

2. The speaker module as claimed in claim 1, wherein the base is made of metal material, and when viewed along a third axis, the base has an H-shaped structure, wherein the third axis is perpendicular to the first axis and the second axis.

3. The speaker module as claimed in claim 2, wherein the base has a first base plate, a second base plate and a third base plate, the second base plate and the third base plate are perpendicular to the first base plate.

4. The speaker module as claimed in claim 3, wherein the first speaker assembly and the second speaker assembly respectively have a first framework and a second frame, which are fixedly disposed on the second base plate and the third base plate.

5. The speaker module as claimed in claim 4, wherein the first speaker assembly and the second speaker assembly respectively have a first coil and a second coil, and the first base plate separates the first coil from the second coil.

6. The speaker module as claimed in claim 5, wherein the third speaker assembly and the fourth speaker assembly respectively have a third framework and a fourth framework, which are respectively fixedly disposed on the second base plate and the third base plate.

7. The speaker module as claimed in claim 6, wherein the third speaker assembly and the fourth speaker assembly respectively have a third coil and a fourth coil, the second base plate separates the first coil from the third coil, and the third base plate separates the second coil from the fourth coil.

8. The speaker module as claimed in claim 7, wherein the first framework to the fourth framework are formed on the base by insert molding technology.

9. The speaker module as claimed in claim 8, wherein when viewed along the second axis, the first framework overlaps a portion of the third framework, and the first framework overlaps a portion of the fourth framework.

10. The speaker module as claimed in claim 7, wherein the first coil is connected to the second coil in parallel, and the third coil is connected to the fourth coil in parallel.

11. The speaker module as claimed in claim 10, wherein the first coil is electrically independent of the third coil.

12. The speaker module as claimed in claim 11, wherein the speaker module further includes a first electrical contact and a second electrical contact, the positive terminals of the first coil and the second coil are electrically connected to the first electrical contact, and the negative terminals of the first coil and the second coil are electrically connected to the second electrical contact.

13. The speaker module as claimed in claim 12, wherein the speaker module further includes a third electrical contact and a fourth electrical contact, the positive terminals of the third coil and the fourth coil are electrically connected to the third electrical contact, and the negative terminals of the third coil and the fourth coil are electrically connected to the fourth electrical contact.

14. The speaker module as claimed in claim 13, wherein the first electrical contact and the second electrical contact are located on a first side of the base, the third electrical contact and the fourth electrical contact are located on a second side of the base, and the second side is opposite to the first side.

15. The speaker module as claimed in claim 7, wherein the first coil is connected to the second coil in series, and the third coil is connected to the fourth coil in series.

16. The speaker module as claimed in claim 15, wherein the third coil and the fourth coil are connected to the first coil and the second coil in parallel.

17. The speaker module as claimed in claim 16, wherein the speaker module further includes a first electrical contact and a second electrical contact, which are respectively disposed on two of the first framework to the fourth framework.

18. The speaker module as claimed in claim 17, wherein the first coil and the third coil are electrically connected to the first electrical contact, and the second coil and the fourth coil are electrically connected to the second electrical contact.

19. The speaker module as claimed in claim 1, wherein a size of the first speaker assembly is larger than a size of the third speaker assembly.
